(19) United States
(12) Patent Application Publication
(10) Pub. No.: US 2008/0285875 A1
(43) Pub. Date: Nov. 20, 2008

(54) IMAGE PROCESSING APPARATUS, METHOD THEREOF, AND PROGRAM

(75) Inventors: Masakazu EBIHARA, Tokyo (JP); Hideki Nabesako, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/054,721

(22) Filed: Mar. 25, 2008

(30) Foreign Application Priority Data
May 18, 2007 (JP) 2007-133063

(51) Int. Cl. G06K 9/36

(52) U.S. Cl. 382/251

(57) ABSTRACT

An image processing apparatus that divides an input image signal into blocks, inversely quantizes image-compressed information, and decodes the image-compressed information by performing an inverse orthogonal transformation. The image processing apparatus includes a first inverse orthogonal transformer capable of performing inverse orthogonal transform processing on inversely quantized coefficient data and capable of performing processing other than the inverse orthogonal transform processing, a second inverse orthogonal transformer capable of performing the inverse orthogonal transform processing on the inversely quantized coefficient data, a decoder decoding quantized and coded transform coefficients, an inverse-quantizer inversely quantizing decoded transform coefficients decoded by the decoder, and indicating distribution information of significant coefficient data as flag information for each block for inverse quantization processing during the inverse quantization, and a selector selectively outputting coefficient data inversely quantized by the inverse quantizer to the first inverse orthogonal transformer or the second inverse orthogonal transformer.

### BACKGROUND OF THE INVENTION

1. Field of the Invention

The present invention relates to an image processing apparatus, a method thereof, and a program, all for processing digital images.

2. Description of Related Art

In recent years, apparatuses compliant with Moving Picture Experts Group (MPEG) type have gained popularity in both information distribution side, such as broadcasting stations and information receiving side, such as at ordinary homes. The MPEG type handles image information by digitizing it, and during handling such information, for the purposes of highly efficient transmission and storage of information, performs compression based on an orthogonal transform such as a Discrete Cosine Transform (DCT) and motion compensation, by utilizing redundancies unique to the image information.

Particularly, MPEG2 (ISO/IEC 13818-2) is defined as a general-purpose image encoding type, and is presently used extensively for both professional and consumer applications as a standard covering both interlace-scanned and sequentially scanned images, as well as standard-resolution and high-definition images.

In the MPEG, there is a growing demand for high-speed codec processing in pursuit of higher resolution and smoother image display, and techniques have been adopted in which dedicated circuit such as ASICs is mainly used to realize high-speed processing.

However, amid the diversified image decompression/compression methods, the techniques with dedicated circuit encounter difficulties in flexibly coping with such methods.

As one solution to achieve the high-speed processing, a technique has been proposed in which a CPU and a reconfigurable accelerator LSI (hereinafter referred to as “accelerator”) as processors are used, the accelerator processes a heavier part of processing, and processing by the accelerator and processing by the CPU are paralleled.

The term “accelerator” means hardware (H/W) and software (S/W) for enhancing a specific function or processing capability, and the accelerator herein used represents H/W substituted for the processing to be performed by the CPU in order to enhance performance.

FIG. 1 is a diagram showing a circuit example having an existing accelerator.

Components of the circuit are a CPU 1, a main memory 2, and an accelerator 3, each of which is connected to a bus 4. The accelerator 3 is provided with a plurality of computation units 5 such as ALU or MAC, and a dedicated RAM (hereinafter referred to as “local memory”) 6 to be used within the accelerator 3.

Furthermore, the accelerator 3 is connected to the CPU 1 and the main memory 2 via the bus 4, and exchanges data via the bus 4.

The accelerator 3 shown in FIG. 1 operates independently from the CPU 1. While the CPU 1 is performing computation processing, the accelerator 3 performs “LOAD”/“STORE” operations of data to/from the local memory 6 and causes the computation units 5 to perform computation processing different from that of the CPU 1, to achieve paralleling processing between the accelerator and the CPU, and to make the more efficient processing.

### SUMMARY OF THE INVENTION

By the way, the accelerator 3 incorporating the local memory 6 therein can compute only data present in the local memory 6, and when the accelerator 3 performs processing, it is necessary to transfer (LOAD) data to the local memory 6 of the accelerator 3 via the bus 4 from the main memory 2, and even after a computation is completed at the accelerator 3, it is necessary to transfer (STORE) data to the main memory 2 from the local memory 6 of the accelerator 3 via the bus 4.

For this reason, even if high-speed computation could be realized by the accelerator 3, the total cycle increases conversely at simple and single-shot computation, when transfer cycles for “LOAD” and “STORE” are considered.

Hence, if the accelerator 3 is assigned to perform all accelerator-capable processing, its load increases conversely, which then increases time required for the CPU 1 to poll the accelerator 3, thereby making it likely to increase the total cycle numbers compared with cases where the CPU 1 alone is used.

FIG. 2 is a diagram illustrating the efficiency by paralleling the CPU and the accelerator when all blocks in a frame are transferred to the accelerator to perform IDCT computations by MPEG.

In FIG. 2, the horizontal axis indicates time axes, i.e., two temporally parallel axes TX1 and TX2 denoting a CPU time axis and an accelerator time axis, respectively.

Furthermore, in FIG. 2, a period T1 in a rectangular box denotes a computation execution period during which the computation is actually performed and a period T2 not surrounded by a rectangular box denotes a period during which the computation is not performed. Further, T3 denotes a computation execution period of the accelerator.

As shown in FIG. 2, as understood from a comparison between the computation execution period T1 of the CPU and the computation execution period T3 of the accelerator, since the accelerator has a high computation load, the CPU is polling the accelerator, thereby increasing the period T2 during which the CPU is idling.

As a result, the efficiency of the paralleling is lowered, and the total cycle numbers increase even if the accelerator is used.

Accordingly, it is desirable to provide an image processing apparatus, a method thereof, and a program, all capable of implementing highly efficient parallel processing at a plurality of processors.

In one aspect of the present invention, there is provided an image processing apparatus that divides an input image signal into blocks, inverse-quantizes the image-compressed information quantized and being subject to an orthogonal transformation per each block, and decodes by performing an inverse orthogonal transformation. The image processing apparatus includes a first inverse orthogonal transformer capable of performing inverse orthogonal transform processing on inversely quantized coefficient data, and capable of performing processing other than the inverse orthogonal transform processing, a second inverse orthogonal transformer capable of performing the inverse orthogonal transform processing on the inversely quantized coefficient data, a decoder for decoding quantized and coded transform coefficients, an inverse quantizer for inversely quantizing transformed coefficients decoded by the decoder, and indicating distribution information about significant coefficient data as flag per each processing block of inverse quantization during the inverse quantization, and a selector for selectively outputting coefficient data inversely quantized by the inverse quantizer to the first inverse orthogonal transformer or the second inverse orthogonal transformer, in response to the flag information of the inverse quantizer.

Preferably, the distribution flag contains coded block pattern information indicative of the presence or absence of the significant coefficient data, and the selector collects and stores only blocks having the significant coefficient data on the basis of the coded block pattern information.

Preferably, the selector stores data each having different processing in a different dedicated buffer, respectively.

Preferably, the selector has a line buffer for transferring data.

Preferably, a threshold value in view of performance of the first inverse orthogonal transformer and that of the second inverse orthogonal transformer are set to the selector, the threshold value is compared with the distribution flag by the inverse quantizer, and the inverse-quantized coefficient data is selectively outputted to the first inverse orthogonal transformer or the second inverse orthogonal transformer.

Preferably, in the selector, the threshold value is set to be a value such that blocks containing the significant coefficient data only in a predetermined line are processed at the first inverse orthogonal transformer.

In a second aspect of the present invention, there is provided an image processing method in which an input image signal is divided into blocks, image-compressed information quantized and being subject to an orthogonal transformation per each block is inversely quantized, and an inverse orthogonal transformation is performed for decoding. The image processing method includes a decoding step of decoding quantized and coded transform coefficients, an inverse-quantizing step of inverse-quantizing decoded transform coefficients by the decoding step, and indicating distribution information of significant coefficient data as flag information per each processing block of inverse quantization during the inverse quantization, a selection processing step of selectively outputting inverse-quantized coefficient data to any of a plurality of inverse orthogonal transformers, in response to the flag information by the inverse-quantizing step, and a transform processing step of performing inverse orthogonal transform processing at the inverse orthogonal transformer to which the inverse-quantized coefficient data is supplied.

In a third aspect of the present invention, there is provided a program that causes a computer to execute image processing in which an input image signal is divided into blocks, image-compressed information quantized and being subject to an orthogonal transformation per each block is inversely quantized, and decoding is performed by an inverse orthogonal transform. The image processing includes decoding processing of decoding quantized and coded transform coefficients, inverse-quantizing processing of inverse-quantizing transform coefficients decoded by the decoding processing, and indicating distribution information about significant coefficient data as flag per each processing block of inverse quantization during the inverse quantization, selection processing of selectively outputting inversely quantized coefficient data to any of a plurality of inverse orthogonal transformers in response to the flag information by the inverse-quantizing processing, and transform processing of performing inverse orthogonal transform processing at the inverse orthogonal transformer to which the inverse-quantized coefficient data is supplied.

According to embodiments of the present invention, quantized and coded transform coefficients are decoded at the decoder and outputted to the inverse quantizer. At the inverse quantizer, the transform coefficients decoded by the decoder are inversely quantized. During the inverse quantization, the inverse quantizer indicates distribution information about significant coefficient data as flag information, per each block of inverse quantization processing.

The selector outputs coefficient data inversely quantized by the inverse quantizer selectively to the first inverse orthogonal transformer or the second inverse orthogonal transformer in response to the distribution flag information of the inverse quantizer.

Then, the first or the second inverse orthogonal transformer to which the inverse-quantized coefficient data is supplied performs an inverse orthogonal transformation.

According to embodiments of the present invention, highly efficient parallel processing in a plurality of processors may be realized.

### BRIEF DESCRIPTION OF THE DRAWINGS

FIG. 1 is a schematic block diagram of a circuit including an accelerator;

FIG. 2 is a diagram for illustrating the efficiency of paralleling a CPU and the accelerator when all blocks in a frame are transferred to the accelerator and being subject to IDCT computations by MPEG;

FIG. 3 is a block diagram showing a configuration of an image processing apparatus according to an embodiment of the present invention;

FIGS. 4A and 4B are diagrams for illustrating inverse quantization processing based on zigzag scanning at an inverse quantizer and flag-based management of coefficients according to the present embodiment;

FIG. 5 is a flowchart showing a flow example from variable length decoding processing (VLD) to IDCT computations in the image processing apparatus according to the present embodiment;

FIG. 6 is a diagram showing a buffering example for different computation paths in the present embodiment;

FIG. 7 is a diagram showing a configuration example of an index for a single block;

FIGS. 8A and 8B are diagrams for illustrating threshold values examples of block coefficient distributions;

FIGS. 9A to 9C are diagrams showing an example of how MB data (after selecting skipped MB) is arranged in frame buffers;

FIG. 10 is a flowchart showing an operation at a computation selector in the present example;

FIGS. 11A to 11F are diagrams showing an example of how a first IDCT transformer (CPU) and a second IDCT transformer (accelerator) are selected by utilizing threshold values;

FIGS. 12A to 12C are diagrams showing an example of how block data is arranged in the frame buffers after utilizing the threshold values;

FIG. 13 is a diagram showing an example of how block data to be transferred to the second IDCT transformer (accelerator) is arranged in a line buffer;

FIG. 14 is a diagram showing an index array example in the line buffer;

FIG. 15 is a diagram showing an example of how block data is arranged in the frame buffers, also indicating address positions relative to an index;

FIG. 16 is a diagram showing a case where N or more blocks are stored in an inter buffer;

FIG. 17 is a diagram for illustrating an example in which N blocks are transferred to the second IDCT transformer (accelerator) for computation;

FIGS. 18A to 18C are diagrams showing an example of how block data is arranged in the frame buffers; and

FIG. 19 is a diagram showing, by way of example, the efficiency of paralleling the first IDCT transformer (CPU) and the second IDCT transformer (accelerator) when computations are performed by utilizing methods according to the present embodiment.

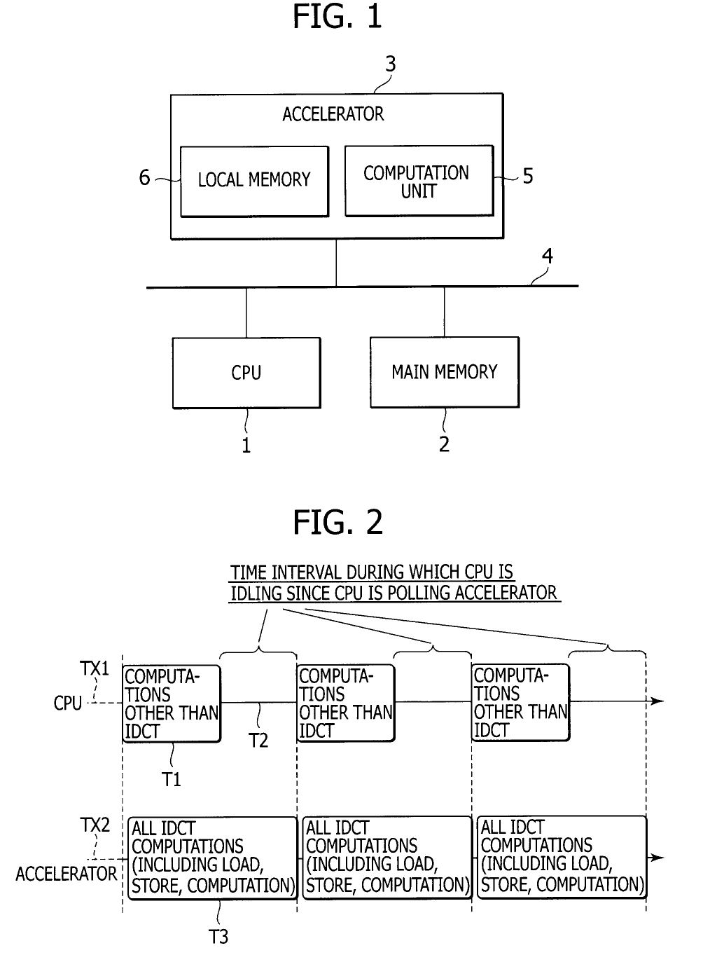

### DETAILED DESCRIPTION OF THE EMBODIMENT

An embodiment of the present invention will now be described with reference to the drawings.

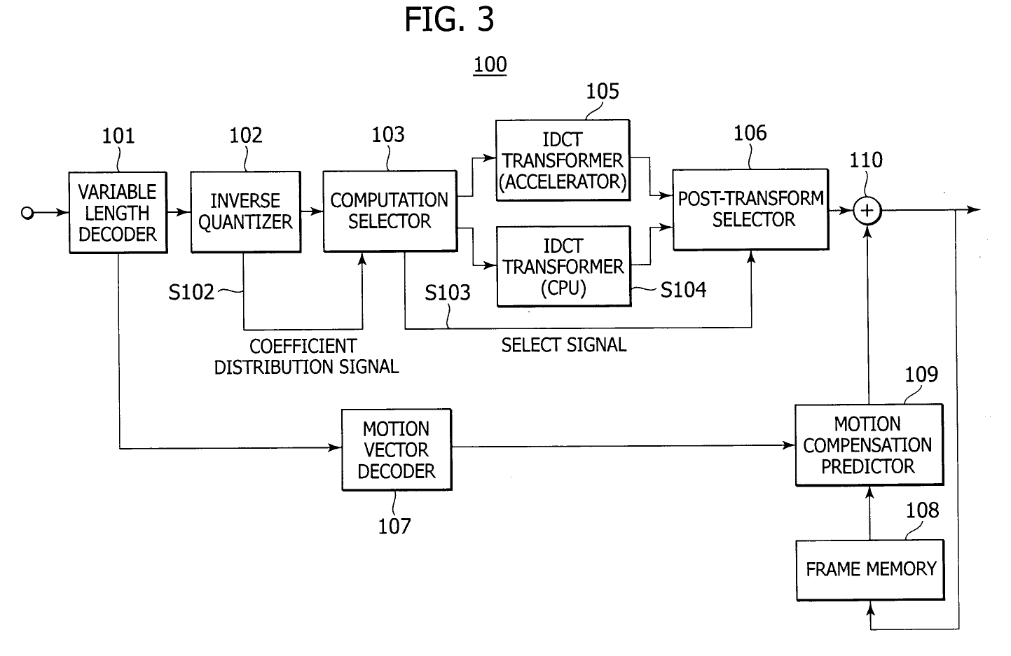

FIG. 3 is a block diagram showing a configuration of an image processing apparatus according to an embodiment of the present invention.

This image processing apparatus 100 has, as shown in FIG. 3, a variable length decoder 101, an inverse quantizer 102, a computation selector 103, a first IDCT transformer (Inverse Discrete Cosine Transformer) 104 as a first inverse orthogonal transformer (processor: a CPU), a second IDCT transformer (accelerator) 105 being a second processor as a second inverse orthogonal transformer, a post-transform selector 106, a motion vector decoder 107, a frame memory 108, a motion compensation predictor 109, and an adder 110.

In the image processing apparatus 100 according to the present embodiment, when the second IDCT transformer (accelerator) 105 is caused to perform IDCT processing in MPEG, it is configured to avoid transfer of data not required to perform IDCT to the second IDCT transformer (accelerator) 105 as much as possible, and regarding data which should be subject to IDCT processing, it is configured to select either the first IDCT transformer (CPU) or the second IDCT transformer (accelerator) 105 for an IDCT computation on the basis of threshold values determined by considering the performance of the first IDCT transformer (CPU) 104 and the performance of the second IDCT transformer (accelerator) 105 by utilizing distribution information of significant coefficient data.

Namely, in the present embodiment, efficient parallel operation is realized as follows. With respect to data not requiring computation or the like, transfer to the second IDCT transformer (accelerator) 105 is skipped. At the same time, even for blocks having significant coefficient data, if a data is judged as being more efficient in terms of the total cycle numbers when it is computed at the first IDCT transformer (CPU) 104 without being transferred to the second IDCT transformer (accelerator) 105 in view of loss caused in the transfer via the bus, the data is subject to the IDCT computation at the first IDCT transformer (CPU) 104.

The variable length decoder 101 performs variable length decoding processing by receiving data coded by a coder (not shown), and outputs quantized data obtained by the processing to the inverse quantizer 102.

The inverse quantizer 102 inversely quantizes the quantized data from the variable length decoder 101 per macroblock (MB), for example, by units of blocks each consisting of, e.g., 8 pixels×8 lines, and outputs resultant DCT (Discrete Cosine Transform) coefficient data to the computation selector 103.

The inverse quantizer 102 indicates distribution information about significant coefficient data as flag information per each block for inverse quantization processing when the decoded quantized data is inversely quantized, and outputs this flag information to the computation selector 103 as a coefficient distribution signal S102.

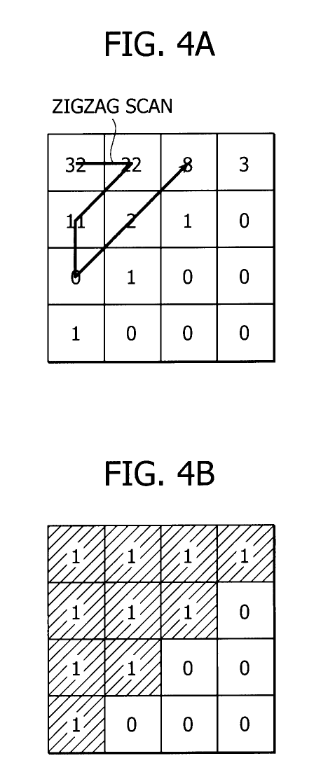

For example, in a case of AVC, which is a coding type standardized by the Joint Video Team (JVT), is the data is inversely quantized while scanning is performed in a zigzag pattern in each 4×4 block, as shown in FIG. 4A.

At this time, the inverse quantizer 102 manages coefficient generating positions within the 4×4 block by flag, as shown in FIG. 4B.

The inverse quantizer 102 indicates the positions of coefficients appearing in the 4×4 block of FIG. 4A by using flags of “0” and “1” as shown in FIG. 4B, and holds (stores) these flags.

The computation selector 103, in response to the coefficient distribution signal S102 from the inverse quantizer 102, avoids transfer of data not requiring IDCT to the second IDCT transformer (accelerator) 105 as much as possible, determines, even for data requiring IDCT, whether an IDCT computation should be performed by the first IDCT transformer (CPU) 104 or by the second IDCT transformer (accelerator) 105 on the basis of the coefficient data distribution in view of the processing capabilities of the first IDCT transformer (CPU) 104 and the second IDCT transformer (accelerator) 105, and supplies the DCT coefficient data from the inverse quantizer 102 to the first IDCT transformer (CPU) 104 or the second IDCT transformer (accelerator) 105 determined to perform the computation.

The computation selector 103 has threshold values Threshold_coef set thereto, which are determined by considering the performance of the first IDCT transformer (CPU) 104 and the second IDCT transformer (accelerator) 105 in advance.

When a distribution flag indicative of a significant coefficient data computed at the inverse quantizer 102 is set as coef_flag, the computation selector 103 judges whether the distribution flag coef_flag is smaller than a threshold value, Threshold_coef or not (whether coef_flag<Threshold_coef), then determines whether the IDCT computation is performed by the first IDCT transformer (CPU) 104 or the second IDCT transformer (accelerator) 105 on the basis of the judgment result, and supplies the DCT coefficient data from the inverse quantizer 102 to the first IDCT transformer 104 or the second IDCT transformer 105, according to the determination result.

In parallel with the supply of the DCT coefficient data to the first IDCT transformer (CPU) 104 or the second IDCT transformer (accelerator) 105, the computation selector 103 outputs a select signal S103 for causing output data of either the first IDCT transformer (CPU) 104 or the second IDCT transformer (accelerator) 105 to be selectively outputted to the adder 110 to the post-transform selector 106.

The first IDCT transformer (CPU) 104 performs the IDCT processing on the DCT coefficient data from the inverse quantizer 102, which is supplied from the computation selector 103, and outputs obtained pixel data to the post-transform selector 106.

Furthermore, the first IDCT transformer (CPU) 104 functions as a CPU capable of performing processing other than the IDCT processing.

The second IDCT transformer (accelerator) 105 includes reconfigurable computation units, performs the IDCT processing on the DCT coefficient data from the inverse quantizer 102, which is supplied from the computation selector 103, and outputs the obtained pixel data to the post-transform selector 106.

The post-transform selector 106 selectively outputs the output data from either the first IDCT transformer (CPU) 104 or the second IDCT transformer (accelerator) 105 to the adder 110 in response to the select signal S103 supplied from the computation selector 103.

The motion vector decoder 107 decodes motion vectors on the basis of data from the variable length decoder 101, and controls an operation of the motion compensation predictor 109 on the basis of a decoding result.

The motion compensation predictor 109 has its operation controlled by the motion vector decoder 107, and supplies no data to the adder 110 when data processed by the adder 110 is an I-picture.

When data processed by the adder 110 is a P-picture, the motion compensation predictor 109 accesses the frame memory 108 to read image data corresponding to a past frame and supplies computed data obtained by performing predetermined computation processing on the image data to the adder 110.

Furthermore, when data processed by the adder 110 is a B-picture, the motion compensation predictor 109 accesses the frame memory 108 to read image data corresponding to a past and a future frames and supplies computed data obtained by performing predetermined computation processing on this image data to the adder 110.

The frame memory 108 is configured to hold image data corresponding to I-pictures and P-pictures out of decoded image data sequentially outputted from the adder 110.

When an I-picture is under processing, the adder 110 is configured to directly output the image data from the first IDCT transformer (CPU) 104 or the second IDCT transformer (accelerator) 105 via the post-transform selector 106, as decoded image data.

Also, when a P-picture or a B-picture is under processing, the adder 110 is configured to performing adding processing on the image data supplied from the first IDCT transformer (CPU) 104 or the second IDCT transformer (accelerator) 105 via the post-transform selector 106 and the computed data from the motion compensation predictor 109 together to obtain and output decoded image data.

The image processing apparatus 100 of the present embodiment realizes efficient parallel processing, by providing the inverse quantizer 102 with a function of showing significant coefficient data distribution information per each processing block of inverse quantization as a flag, and by selecting whether IDCT is computed at the first IDCT transformer (CPU) 104 or the second IDCT transformer (accelerator) 105 on the basis of threshold values pre-determined in view of the performance of the first IDCT transformer (CPU) 104 and that of the second IDCT transformer (accelerator) 105, by utilizing the flag shown by the inverse quantizer 102.

An operation of the image processing apparatus 100 according to the present embodiment will be described below, by including more specific functions and configurations.

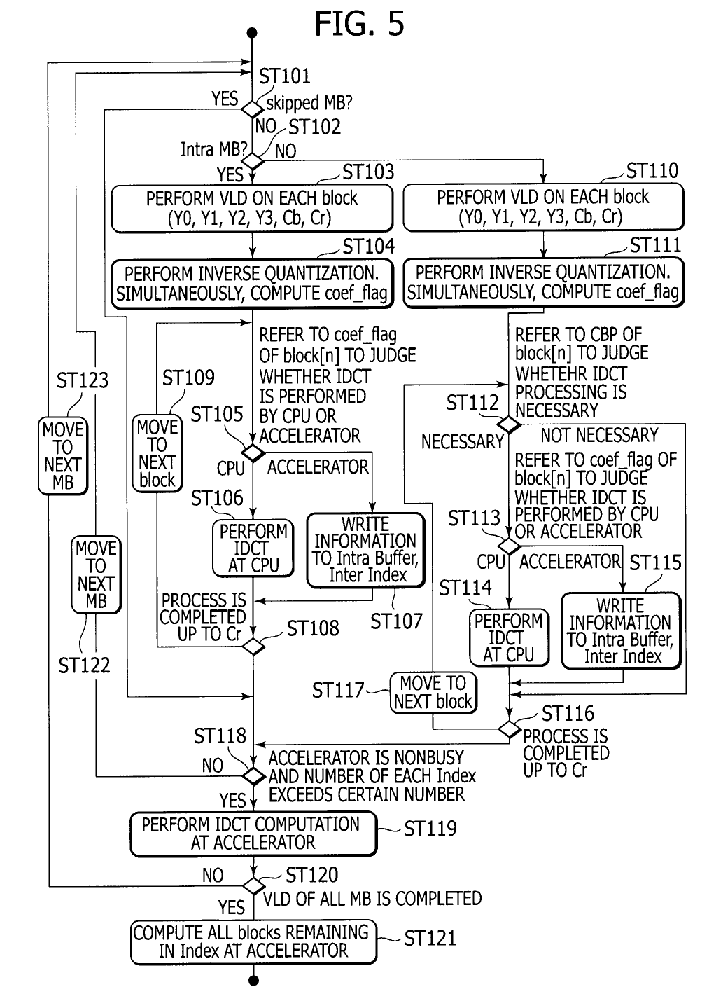

FIG. 5 is a flowchart showing a flow example from variable length decoding processing (VLD) to IDCT (Inverse Discrete Cosine Transform) computations in the image processing apparatus according to the present embodiment.

FIG. 5 represents operations performed for a frame (1 VOP) by respective functional blocks of the variable length decoder 101, inverse quantizer 102, computation selector 103, first IDCT transformer (CPU) 104, second IDCT transformer (accelerator) 105, and post-transform selector 106 in FIG. 3, in the form of a flow diagram. The image processing apparatus 100 repeats operation of steps ST101 to ST123 as shown in FIG. 5 for each frame.

First, processing needs to be changed according to the MB type of a macroblock (hereinafter referred to as “MB”) to be processed.

As described above, in order to achieve efficient paralleling, it is required to avoid transfer of data not requiring IDCT to the second IDCT transformer (accelerator) 105 as much as possible.

For any skipped MB, no IDCT is not required, but only required to copy reference frame, therefore transfer of the block data to the second IDCT transformer (accelerator) 105 is not required.

Then, an intra MB and an inter MB need be distinguished. In some accelerators (second IDCT transformers 105), different computation paths may be used for intra MB and inter MB, respectively.

If an accelerator has different computation paths, the accelerator needs to change the paths every time an intra MB or an inter MB comes, thereby increasing numbers of cycle for changing the computation paths each time path is changed.

In the present embodiment, in order to prevent such an inconvenience, different buffers are provided for data having different computation paths, such as intra MB and inter MB, to store the data therein.

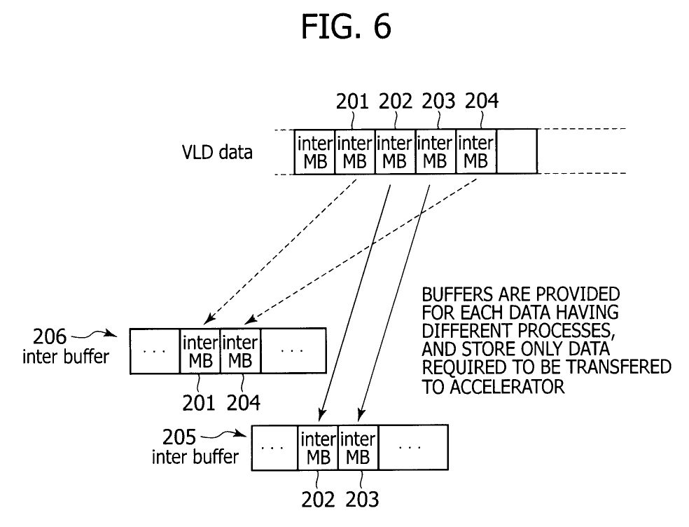

FIG. 6 is a diagram showing a buffering example for different computation paths in the present embodiment.

As shown in FIG. 6, a certain frame (VLD data) is supposed to contain an inter MB 201, an intra MB 202, an intra MB 203, and an inter MB 204.

The second IDCT transformer (accelerator) 105 has different paths for the processing of an intra MB and that of an inter MB, respectively, and if transfer is made to the second IDCT transformer (accelerator) 105 in this order, it is required to change computation paths of the second IDCT transformer (accelerator) 105 per each MB, thereby causing wasteful overhead.

To overcome this situation, in the present embodiment, as shown in FIG. 6, a plurality of buffers having different computation path are provided beforehand, such as an intra buffer 205 and an inter buffer 206.

Only data required to be transferred to the second IDCT transformer (accelerator) 105 is stored in the prepared intra and inter buffers 205, 206. In the example of FIG. 6, the intra MBs 202, 203 are stored in the intra buffer 205, whereas the inter MBs 201, 204 are stored in the inter buffer 206.

Furthermore, in storing the data in the intra buffer 205 and the inter buffer 206, indices (index) are prepared for each buffer in order to “STORE” data in a main memory (or the frame memory 108) after completion of a computation at the second IDCT transformer (accelerator) 105 per each buffer.

Here, the term “index” means an array storing parameters of blocks necessary in issuing a “STORE” transfer command from the second IDCT transformer (accelerator) 105.

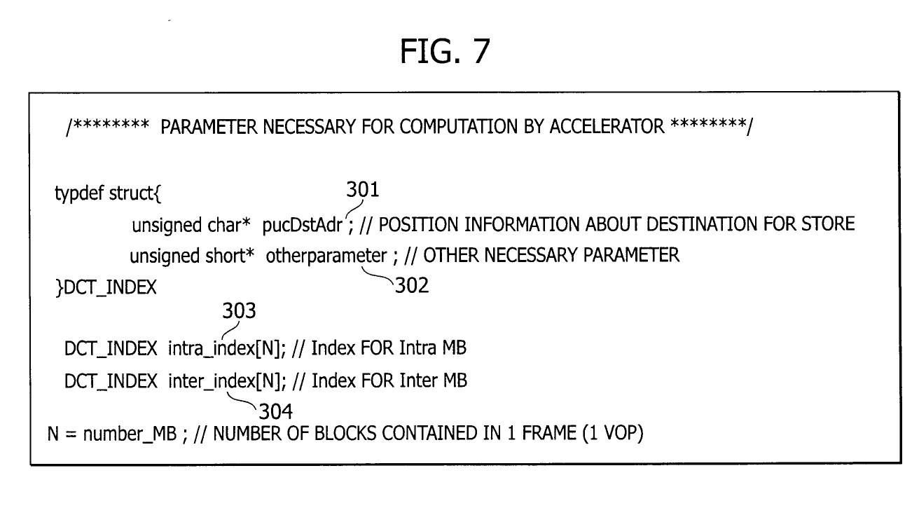

FIG. 7 is a diagram showing a configuration example of an index for a single block.

In the example of FIG. 7, it is supposed that an “INDEX” stores a starting address 301 of a block necessary to “STORE” an IDCT processing result computed by the second IDCT transformer (accelerator) 105 in the frame memory 108 for output, a parameter 302 necessary for the computation by the accelerator, and the like.

Parameters 302 as many as the number of blocks contained in a single frame are prepared in the form of an array.

At this time, the computation selector 103 prepares two indices, i.e., an index 303 for intra MB and an index 304 for inter MBs, in order to provide different buffers per each computation path, respectively, and performs “LOAD”/“STORE” to/from the second IDCT transformer (accelerator) 105.

A block-by-block process will be described next.

An MB is a unit in a decoding process, and has a data size of 16×16. The MB is formed from four luminance blocks (Y0, Y1, Y2, Y3), two color-difference blocks (Cb, Cr), and a macroblock header.

The macroblock header includes a variable length code VLC called a Coded Block Pattern (CBP), which is information indicative of the presence/absence of data effective for specific blocks contained in MB.

When it is judged from a check on the CBP that significant coefficient data is absent, it is useless to perform an IDCT. Thus, in order to eliminate wasteful operation and to reduce the cycle number, blocks having significant coefficient data are collected.

However, all the blocks thus collected maybe transferred to the second IDCT transformer (accelerator) 105 to perform computation. However, depending on a mutual relationship between the performance of the first IDCT transformer (CPU) 104 and that of the second IDCT transformer (accelerator) 105, heavy load may be put on the second IDCT transformer (accelerator) 105 when the collected block data is all transferred. In such a case, as described with reference to FIG. 2, a cycle number for polling the second IDCT transformer (accelerator) 105 by the first IDCT transformer (CPU) 104 does increase conversely, thereby increasing the total cycle numbers.

Thus, in the present embodiment, as mentioned earlier, the computation selector 103 determines threshold values in view of the performance of the first IDCT transformer (CPU) 104 and that of the second IDCT transformer (accelerator) 105, and decides whether computations are performed at the first IDCT transformer (CPU) 104 or the second IDCT transformer (accelerator) 105, per each block.

Specifically, when denoting a threshold value as a selection standard of an IDCT computation as Threshold-coef, and a distribution flag (flag) of a significant coefficient data computed by the inverse quantizer 102 as coef_flag, the computation selector 103 judges whether coef_flag<Threshold_coef or not, and judges whether or not an IDCT computation is performed at the first IDCT transformer (CPU) 104 or the second IDCT transformer (accelerator) 105, per each block.

With reference to the distribution flag coef_flag, when coefficient data is remained only in DC components or coefficient data is remained only in AC components, computation is performed each time loaded (LOAD) to the accelerator, and cycle number may decrease if pre-processed at the first IDCT transformer (CPU) 104 rather than loading (“LOAD”).

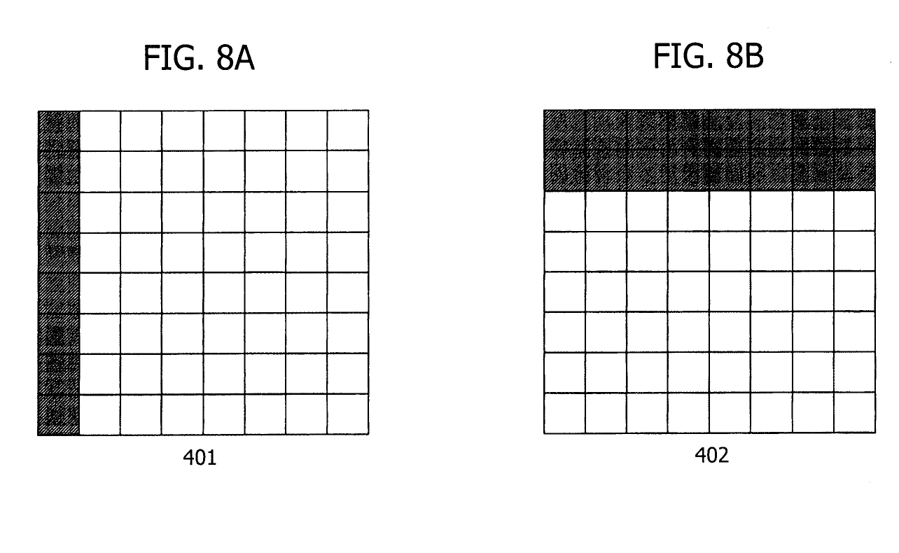

Thus, in this example, As shown in FIG. 8A, regarding blocks of coefficient distribution, such as a block 401 being 8×8 block at maximum and having a significant coefficient data is found in a first vertical line (First Line), and as shown in FIG. 8B, a block 402 in which significant coefficient data is distributed at most up to a second horizontal line (Second Line), threshold values are determined such that IDCT computation is performed by the first IDCT transformer (CPU) 104.

Let a threshold value for the block 401 be Threshold_coef1 and a threshold value for the block 402 be Threshold_coef2.

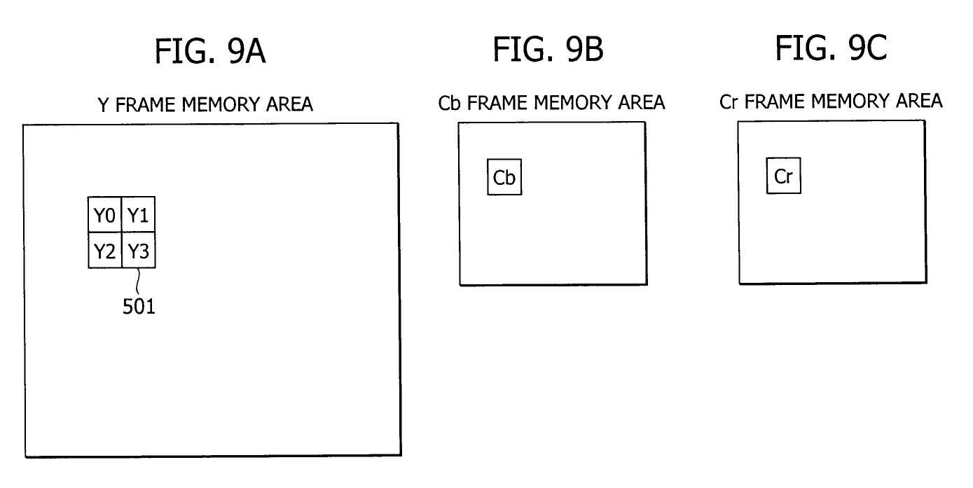

Here, a processing flow in the present embodiment will be described, taking an example in which an inter MB such as shown in FIGS. 9A to 9C is processed.

When an inter MB such as shown in FIGS. 9A to 9C exists, first, VLD processing is performed by the variable length decoder 101. The inverse quantizer 102 inversely quantizes (IQ) and at the same time, checks the distribution of the DCT coefficient data of each VLD-processed block. Then, the result is stored as distribution flag, coef_flag and supplied to the computation selector 103 as a coefficient distribution signal S102.

Then, the computation selector 103 checks the CBP of the DCT coefficient data after inverse quantization supplied thereto, to check whether significant coefficient data is present or not. If no significant coefficient data is present, there is no need to perform IDCT processing, and thus the block is eliminated.

In FIG. 9A, let it be assumed that a Y3 block 501 has no significant coefficient data. Thus, only the Y3 block 501 is eliminated, and other blocks Y0, Y1, Y2, Cb, Cr will be subject to an IDCT computation.

Thereafter, the computation selector 103 selects whether IDCT computation is performed at the first IDCT transformer (CPU) 104 or the second IDCT transformer (accelerator) 105.

The threshold values used for this example are a threshold value Threshold-coef1 such as the block 401 of FIG. 8A and a threshold value Threshold_coef2 such as for the block 402 of FIG. 8B.

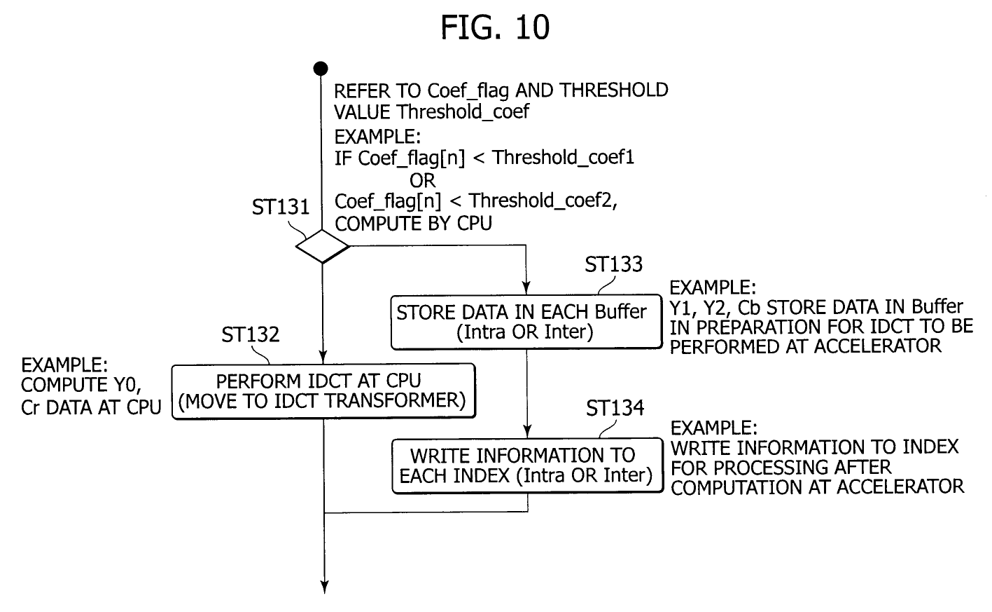

FIG. 10 is a flowchart showing an operation by the computation selector 103 in this example.

The computation selector 103 makes comparisons to judge between coef_flag<Threshold_coef1 or coef_flag<Threshold_coef2, for each block (ST131).

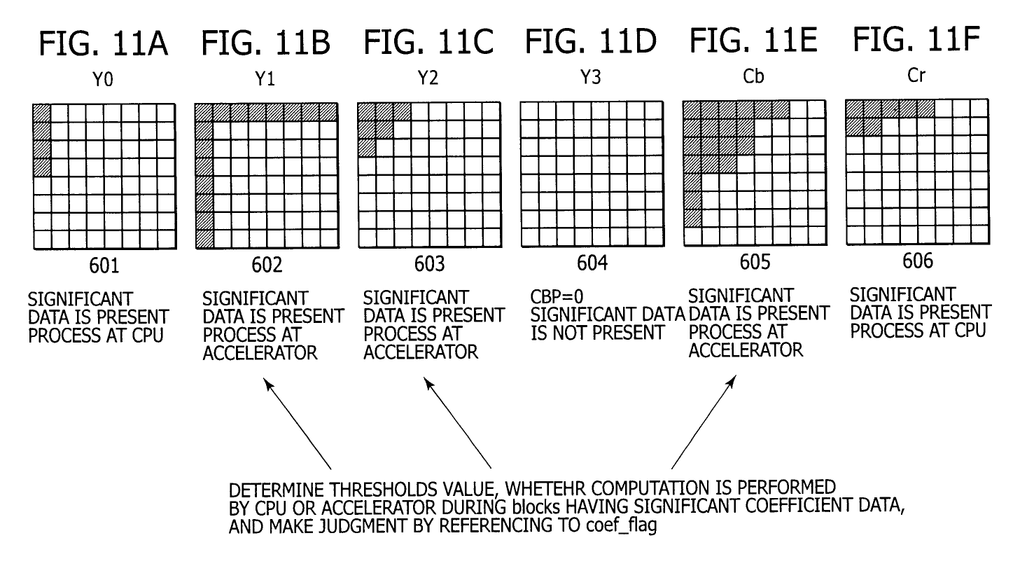

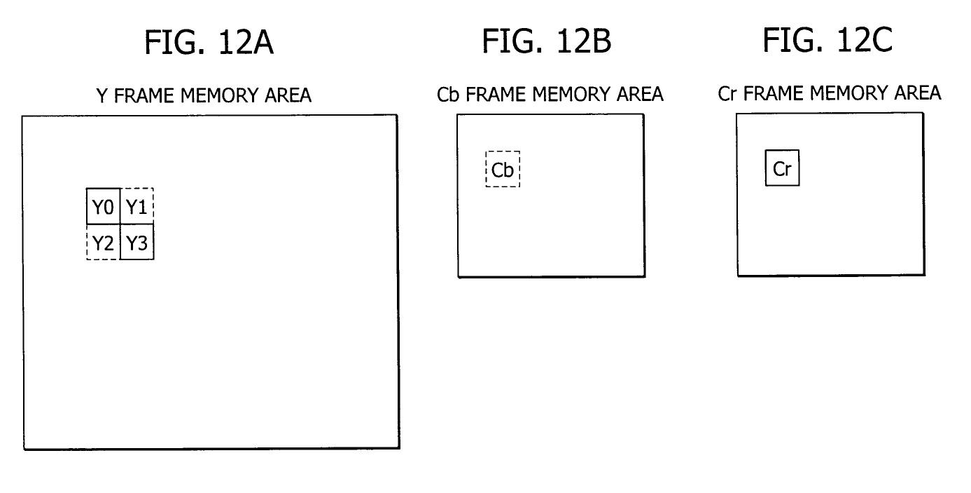

When each block has any of coefficient distributions such as shown in FIGS. 11A to 11F (each filled box is supposed to contain coefficient data), coef_flag<Threshold_coef1 stands at a Y0 block 601 of FIG. 11A, and coef_flag<Threshold_coef2 stands at a Cr block 606 of FIG. 11F, so that the blocks have coefficient distributions within the threshold value ranges, respectively. Thus, an IDCT computation is performed instantly by the first IDCT transformer (CPU) 104, and IDCT results are stored in output frame buffers such as shown in FIGS. 12A to 12C (ST132).

Furthermore, a Y1 block 602, a Y2 block 603, and a Cb block 605 are beyond threshold value range, therefore data is transferred to the second IDCT transformer (accelerator) 105 for computation.

Then, the Y1 block 602, the Y2 block 603, and the Cb block 605 determined to be computed by the second IDCT transformer (accelerator) 105 have their DCT coefficients stored in an inter buffer 206 as shown in FIG. 6 for their computation by the second IDCT transformer (accelerator) 105 (ST133).

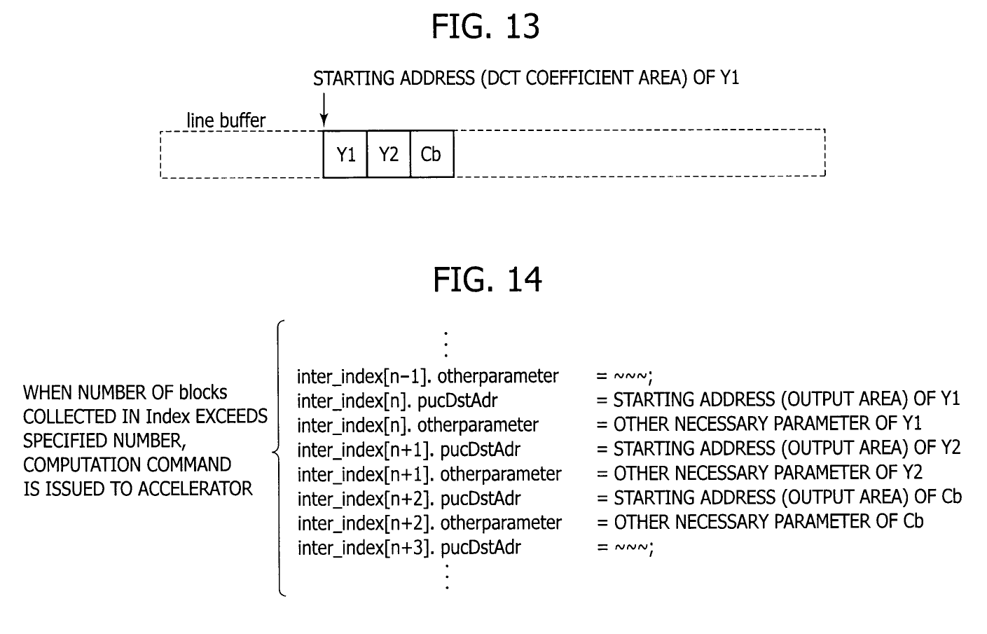

In this example, as shown in FIG. 13, a line buffer 210 to be transferred to the second IDCT transformer (accelerator) 105 consecutively stores the Y1 block 602, the Y2 block 603, and the Cb block 605.

Also, in parallel with the storage in the line buffer, an index necessary for the transfer is prepared as shown in FIG. 7.

As mentioned earlier, the buffers and indices are provided separately at intra MB and inter MB for eliminating loss of computation path switching. In this example, the buffer 206 for inter MB is used.

To prepare the index, starting addresses of each block in output buffers to be stored (STORE) from the second IDCT transformer (accelerator) 105 after an IDCT computation are required.

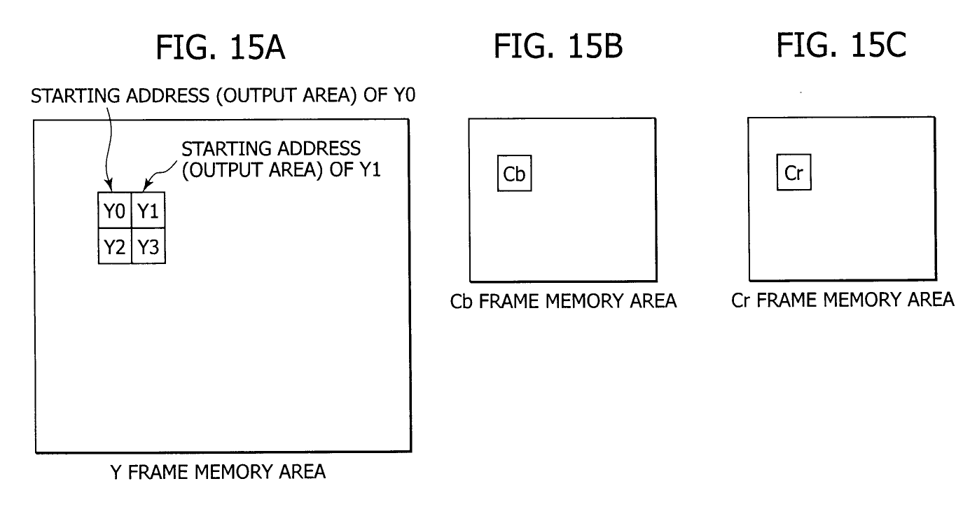

Thus, in step ST134, the data are written to the index as shown in FIG. 14 (examples of starting addresses in output areas are shown in FIG. 15). This is a flow of collecting an index of blocks having significant coefficient data to be transferred to the second IDCT transformer (accelerator) 105 with respect to a single MB.

Then, every time the a serie of flows for a single MB ends, the number of blocks collected in the index is checked. When the number of blocks exceeds a specified numbers and the second IDCT transformer (accelerator) 105 is “nonbusy” state, a computation command is issued to the second IDCT transformer (accelerator) 105 for the blocks having significant coefficient data as a group. In this case, the number of blocks to be transferred to the second IDCT transformer (accelerator) 105 at a time is determined by the performance of the first IDCT transformer (CPU) 104 and that of the second IDCT transformer (accelerator) 105.

However, if the second IDCT transformer (accelerator) 105 is still processing previously transferred blocks and at a busy state, a computation command is not issued.

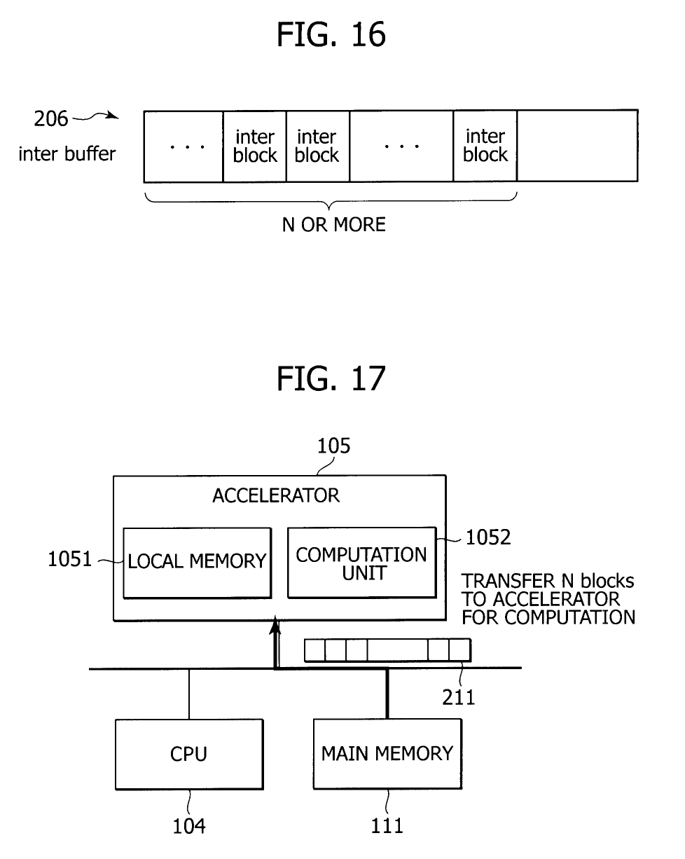

In an example, when N or more blocks are stored in the inter buffer 206 as shown in FIG. 16, N block data 211 is transferred to a local memory 1051 of the second IDCT transformer (accelerator) 105 by using a bus 112 from a main memory 111, as shown in FIG. 17, and the transferred data is computed by a computation unit 1052.

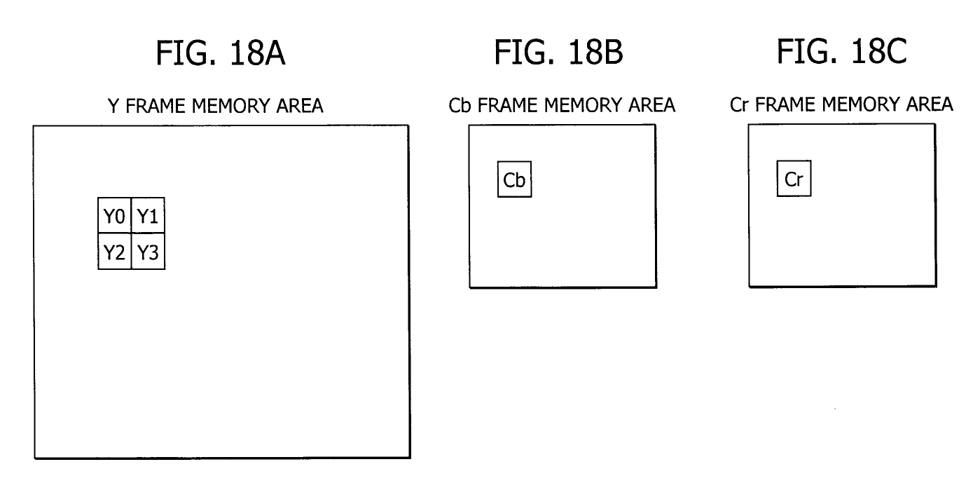

When the second IDCT transformer (accelerator) 105 completes its computation, the post-transform selector 106 refers to a select signal S103 indicative of the index prepared by the computation selector 103, and stores IDCT computation results in the output buffers as shown in FIGS. 18A to 18C.

Furthermore, while the second IDCT transformer (accelerator) 105 is in operation, the first IDCT transformer (CPU) 104 is paralleled to perform other processing. Furthermore, by repeating such a processing flow, the efficiency of the paralleling is enhanced.

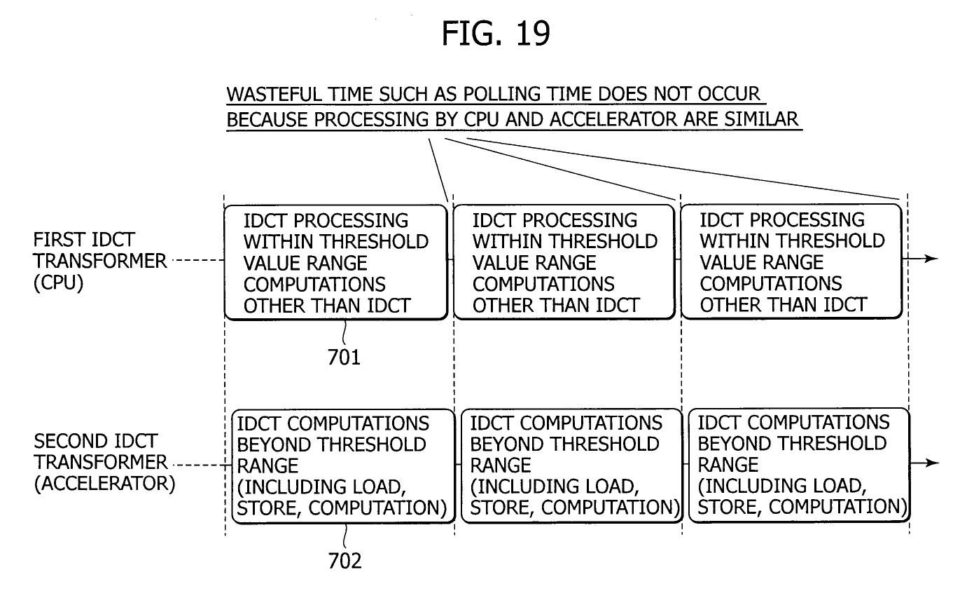

FIG. 19 is a diagram showing, by way of an example, the efficiency of paralleling the first IDCT transformer (CPU) 104 and the second IDCT transformer (accelerator) 105 when computations are performed according to methods of the present embodiment.

Since a threshold value is set in view of the performance of the first IDCT transformer (CPU) 104 and that of the second IDCT transformer (accelerator) 105, and wasteful overhead is reduced, a computation execution period 701 of the first IDCT transformer (CPU) 104 and a computation execution period 702 of the second IDCT transformer (accelerator) 105 become comparatively equal, thereby reducing an idling period of the CPU compared with the case of FIG. 2.

As described above, according to the present embodiment, there are provided the inverse quantizer 102 and the computation selector 103. Namely, the inverse quantizer 102 indicates, during inverse quantization of decoded quantized data, distribution information of significant coefficient data per each processing block of inverse quantization as flag and outputs the flag information as a coefficient distribution signal S102. The computation selector 103, in response to the coefficient distribution signal S102 from the inverse quantizer 102, avoids transfer of data not requiring IDCT to the second IDCT transformer (accelerator) 105 as much as possible, and, for data requiring IDCT, determines whether IDCT computation is performed at the first IDCT transformer (CPU) 104 or the second IDCT transformer (accelerator) depending on the coefficient data distribution, in view of the performance of the first IDCT transformer (CPU) 104 and that of the second IDCT transformer (accelerator) 105, and supplies DCT coefficient data supplied from the inverse quantizer 102 to the first IDCT transformer (CPU) 104 or the second IDCT transformer (accelerator) 105 determined to perform the IDCT computation. Accordingly, efficient paralleling by a plurality of processors can be realized, and the cycle numbers can be reduced.

When the above configuration is actually implemented on an MPEG4 decoder, a reduction of about ten cycles was achieved.

Furthermore, according to the methods described above, a program compliant with the procedure and the program to be executed on a computer such as a CPU may be provided.

Furthermore, it can also be configured that such a program is executed by being accessed by a computer set with a recording medium, such as a semiconductor memory, a magnetic disk, an optical disk, and a floppy (trademark) disk and the like.

It should be understood by those skilled in the art that various modifications, combinations, sub-combinations and alterations may occur depending on design requirements and other factors insofar as they are within the scope of the appended claims or the equivalents thereof.

The present document contains subject matter related to Japanese Patent Application No. 2007-133063 filed in the Japanese Patent Office on May 18, 2007, the entire content of which being incorporated herein by reference.

What is claimed is:

1. An image processing apparatus that divides an input image signal into blocks, inversely quantizes image-compressed information quantized by being subject to an orthogonal transformation per each block, and decodes the image-compressed information by performing an inverse orthogonal transformation, the image processing apparatus comprising:
a first inverse orthogonal transformer capable of performing inverse orthogonal transform processing on inversely quantized coefficient data and capable of performing processing other than the inverse orthogonal transform processing;
a second inverse orthogonal transformer capable of performing the inverse orthogonal transform processing on the inversely quantized coefficient data;
a decoder decoding quantized and coded transform coefficients;
an inverse-quantizer inversely quantizing decoded transform coefficients decoded by the decoder, and indicating distribution information of significant coefficient data as flag information for each block for inverse quantization processing during the inverse quantization; and
a selector selectively outputting coefficient data inversely quantized by the inverse quantizer to the first inverse orthogonal transformer or the second inverse orthogonal transformer, in response to the flag information from the inverse quantizer.

2. The image processing apparatus according to claim 1, wherein;
the distribution flag includes coded block pattern information indicative of the presence or absence of the significant coefficient data; and
the selector collects and stores only blocks having the significant coefficient data on the basis of the coded block pattern information.

3. The image processing apparatus according to claim 2, wherein;
the selector stores data having different processings in different dedicated buffers, respectively.

4. The image processing apparatus according to claim 3, wherein;
the selector has a line buffer for transferring data.

5. The image processing apparatus according to claim 1, wherein;
the selector has a threshold value set thereto in view of performance of the first inverse orthogonal transformer and that of the second inverse orthogonal transformer, compares the threshold value with the distribution flag from the inverse quantizer, and selectively outputs the inversely quantized coefficient data to the first inverse orthogonal transformer or the second inverse orthogonal transformer.

6. The image processing apparatus according to claim 3, wherein;
the selector has a threshold value set thereto in view of performance of the first inverse orthogonal transformer and that of the second inverse orthogonal transformer, compares the threshold value with the distribution flag from the inverse quantizer, and selectively outputs the inversely quantized coefficient data to the first inverse orthogonal transformer or the second inverse orthogonal transformer.

7. The image processing apparatus according to claim 5, wherein;
in the selector, the threshold value is set to be a value in which blocks containing the significant coefficient data only in predetermined lines are processed at the first inverse orthogonal transformer.

8. The image processing apparatus according to claim 6, wherein;
in the selector, the threshold value is set to be a value in which blocks containing the significant coefficient data only in predetermined lines are processed at the first inverse orthogonal transformer.

9. An image processing method in which an input image signal is divided into blocks, image-compressed information quantized by being subject to an orthogonal transformation per each block is inversely quantized, and the image-compressed information is decoded by an inverse orthogonal transformation, the image processing method comprising:
a decoding step of decoding quantized and coded transformation coefficients;
an inversely quantizing step of inversely quantizing transformation coefficients decoded by the decoding step, and indicating distribution information of significant coefficient data as flag information per each block for inverse quantization processing during the inverse quantization;
a selection processing step of selectively outputting inversely quantized coefficient data to any of a plurality of inverse orthogonal transformers in response to the flag information of the inverse quantizing processing; and
a transform processing step of performing inverse orthogonal transform processing at the inverse orthogonal transformer to which the inversely quantized coefficient data is supplied.

10. A program that causes a computer to execute image processing in which an input image signal is divided into blocks, image-compressed information quantized by being subject to an orthogonal transformation per each blocks is inversely quantized, and the image-compressed information is decoded by an inverse orthogonal transformation, the image processing including:
decoding processing of decoding quantized and coded transformation coefficients;
inverse-quantizing processing of inversely quantizing transformation coefficients decoded by the decoding step, and indicating distribution information of significant coefficient data as flag information per each block for inverse quantization processing during the inverse quantization;
selection processing of selectively outputting inverse-quantized coefficient data to any of a plurality of inverse orthogonal transformers in response to the flag information of the inverse-quantizing processing; and
transform processing of performing inverse orthogonal transform processing at the inverse orthogonal transformer to which the inversely quantized coefficient data is supplied.
